(19) United States
(12) Patent Application Publication
(10) Pub. No.: US 2026/0221913 A1
(43) Pub. Date: Jul. 30, 2026

(54) SYSTEM FOR MULTI-VARIABLE FLUX MEMORY MOTOR CONFIGURATION

(71) Applicant: Jacobi Motors, Inc., Webster, TX (US)

(72) Inventors: Ahmed Salah Morsy, Sugar Land, TX (US); Chaitanya Kumar Ravipalli, Richmond, TX (US); Pierre-Olivier Gourmelon, Sugar Land, TX (US); Nathan Rukavina, Pearland, TX (US)

(73) Assignee: Jacobi Motors, Inc., Webster, TX (US)

(21) Appl. No.: 19/636,109

(22) Filed: Apr. 1, 2026

Related U.S. Application Data
(63) Continuation of application No. 18/594,430, filed on Mar. 4, 2024, now Pat. No. 12,614,998.

(51) Int. Cl. H02P 21/22; H02P 5/74

(52) U.S. Cl. CPC H02P 21/22; H02P 5/74; H02P 2207/05

(57) ABSTRACT

A system for multi-Variable Flux Memory Motor (VFMM) configuration includes a set of VFMMs connected to one or more drivetrains, the set of VFMMs being configured to convert kinetic energy of the one or more drivetrains into electric power or vice-versa. The system includes a controller configured to selectively change a magnetization state of one or more VFMMs from the set of VFMMs based on power requirements. The system changes the magnetization state of the set of VFMMs based on an optimal magnetization configuration determined for each power requirement.

### BACKGROUND

Synchronous electric motors, such as Variable Flux Memory Motors (VFMMs) or Wound Field Synchronous Motors, have a wide range of applications in industrial, commercial, and residential, applications, such as fans, pumps, compressors, elevators, refrigerators, industrial machinery, and electric motor vehicles because of their high efficiencies. Also, because of using permanent magnets instead of windings in the rotors of the synchronous electric motors, there is less need for rotor cooling. These advantages along with others (e.g., being brushless) make the synchronous electric motors popular where high torque, high efficiency, or low maintenance for electric motors is needed.

In many vehicles, a single motor or an engine may be used for driving a drivetrain. Two-wheel drive vehicles typically have the drivetrain connected to a single axle supporting two wheels. Four-wheel drive vehicles, on the other hand, have the drivetrain connected to two axles supporting two wheels each. While some electric vehicles have one motor used for propulsion on one axel, it is still preferable to have multiple motors in drivetrains for improved performance and torque.

It has been observed that vehicles, particularly multi-axle vehicles, benefit from having a plurality of motors that drive the drivetrain. Multiple motors each connected to corresponding drivetrains have shown to be particularly effective in heavy-duty vehicles or performance vehicles. In some solutions, the number of synchronous motors engaged with the corresponding drivetrain is suitably adjusted based on power requirements using axle disconnect mechanisms or clutches.

However, increased weight and rollover losses are known problems associated with multi-motor drivetrains. Some solutions proposed for ameliorating such problems include use of combination of permanent magnet motors and induction motors, or use of the axle disconnect or clutch mechanisms to mechanically engage or disengage motors from the corresponding drivetrain based on requirement. Combining different types of motors (such as internal permanent magnet motors and induction motors) have been found not to provide city driving efficiencies. They also require different manufacturing lines for each type of motor. Further, axle disconnect mechanisms and clutches are implemented as mechanical or electromechanical systems that are susceptible to energy losses, and wear and tear during operation. Such mechanisms are also not acceptably reliable during a fault, and also add to the cost, weight, and complexity of the vehicle.

Additionally, synchronous motors that use permanent magnets may also cause iron, eddy, and copper losses due to the continued magnetized state of the motors, particularly during high-speed operations. Further, engagement and disengagement of the synchronous motors may have to be carefully controlled to optimize for energy efficiency.

Adjusting magnetization states of synchronous motors, such as VFMMs, may allow energy efficiency to be maintained while providing speed and torque outputs within a fixed and preconfigured operating range. The preconfigured operating range within which the VFMM may provide speed and torque outputs may correspond to limitations presented by hardware specifications of the VFMM, such as number of turns in the coils of stator, radius of VFMM, geometry of rotor, and the like. While use of multiple VFMMs may be desirable to further extend the operating range, existing solutions fail to provide means for efficiently coordinating the operation of multiple VFMMs. Further existing solutions do not allow for multiple VFMMs to be controllably engaged with or disengaged from corresponding drivetrains based on speed and torque output required by a user.

Therefore, there is a need for a system for multi-VFMM configuration. Further, there is a need for a system for controllably engaging a plurality of VFMMs to drive corresponding drivetrains based on requirements.

### SUMMARY

In an aspect, embodiments of the disclosure are directed towards a system for multi-VFMM configuration. The system includes a set of VFMMs connected to one or more drivetrains, the set of VFMMs being configured to convert kinetic energy of a gear train into electric power or vice-versa. The system includes a controller configured to selectively change a magnetization state of one or more VFMMs from the set of VFMMs based on power requirements.

By selectively changing the magnetization states of the set of VFMMs, the system may allow any combination of VFMMs to drive the drivetrains based on the power requirements. The system may select an optimal magnetization configuration suitable for efficiently fulfilling the power requirements input by the user.

Other aspects of the disclosure will be apparent from the following description and the appended claims.

### BRIEF DESCRIPTION OF THE DRAWINGS

FIG. 1 shows a block diagram of a vehicle having a multi-Variable Flux Memory Motor (VFMM) configuration, according to one or more embodiments.

FIG. 2 shows a circuit diagram of the multi-VFMM configuration in a plurality of orientations, according to one or more embodiments.

FIGS. 3A-3C show efficiency maps of a system having the multi-VFMM configuration, according to one or more embodiments.

FIG. 4 shows a flowchart of a method for controlling a set of VFMMs based on power requirements, according to one or more embodiments of the present disclosure.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it would have been apparent to one of ordinary skill in the art that the disclosure may be practiced without these specific details. In other instances, well-known features have not been described in detail to avoid unnecessarily complicating the description.

As used herein, “about” means approximately or nearly, and in the context of a numerical value or range set forth means ±10% of the numeric value.

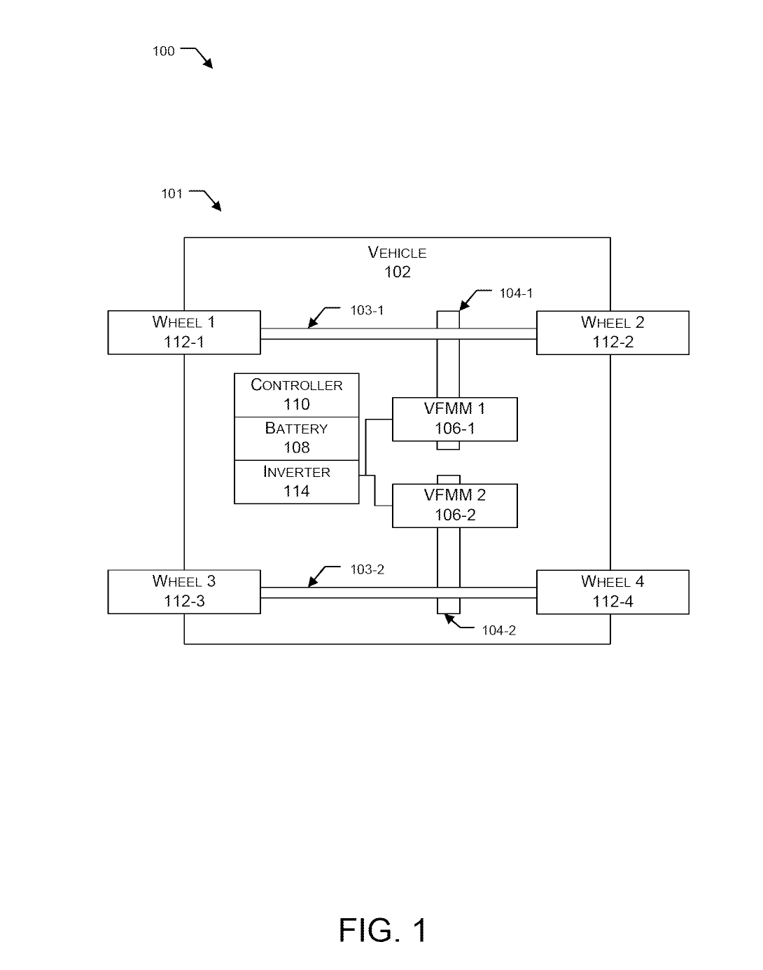

Referring to FIG. 1, a block diagram (100) of a system (101) for multi-Variable Flux Memory Motor (VFMM) configuration in a vehicle (102) is illustrated. As shown, the system (101) may include a set of VFMMs, such as first and second VFMMs (106-1, 106-2) (collectively referred to as VFMMs (106)). The VFMMs (106) may be configured to drive one or more drivetrains (104-1, 104-2) (collectively referred to as drivetrains (104)). Each VFMM (106) may be connected to a corresponding drivetrain. In some embodiments, the first VFMM (106-1) may be connected to a first drivetrain (104-1) and the second VFMM (106-2) may be connected to a second drivetrain (104-2). In some embodiments, the system (101) includes a controller (110) configured to control magnetization states of the VFMMs (106) based on power requirements. In some embodiments, the system (101) may also include a battery (108) and an inverter (114) configured to supply power to the VFMMs (106).

In some embodiments, the VFMMs (106) may be connected to, and configured to drive, one or more wheels, such as wheels (112-1, 112-2, 112-3, 112-4) (collectively referred to as the wheels (112)). In some embodiments, the VFMMs (106) may be configured to propel the vehicle (102) by turning/rotating the wheels (112). While FIG. 1 describes embodiments where the vehicle (102) is a four-wheeled vehicle, the system (101) may be suitably adapted for implementations thereof in vehicles having any number of wheels. The vehicle (102) may be any one of including, but not be limited to, electric vehicle, hybrid vehicle, and the like. Examples of the vehicle (102) include, but not be limited to, two-wheelers, three-wheelers, cars, vans, trucks, buses, hydraulic vehicles, electric trains, locomotives, boats, ships, submarines, and the like.

In some embodiments, the VFMMs (106) may be connected to the wheels (112) through the drivetrains (104). The drivetrains (104) may be configured to transmit/deliver power from the VFMMs (106) to the corresponding wheels (112). In some embodiments, the drivetrains (104), in turn, may be connected to the wheels (112) through axles (103-1, 103-2) (collectively referred to as axles (103)). In some embodiments, pairs of wheels, viz. the wheels (112-1, 112-2) indicative of front wheels, in some examples, and wheels (112-3, 112-4) indicative of rear wheels, in some examples, may be connected to a corresponding axle, such as axles (103-1, 103-2) respectively. The axles (103) may allow rotation of the drivetrains (104) to be translated into rotation of the corresponding wheels (112). In some embodiments, the drivetrains (104) may be connected to the axles (103) through corresponding differentials (not shown). The differentials may be configured to allow the pairs of wheels (112-1, 112-2), and wheels (112-3, 112-4), to rotate at different rates/speeds/revolutions per minute, such as during turns or to prevent slippages.

In some preferred embodiments, the system (101) may include one or more of the drivetrains (104) connected to the set of VFMMs (106) on one end, and to a corresponding axle from the axles (103) on the other end thereof. In other embodiments, a single drivetrain may be connected to the set of VFMMs (106) and the axles (103). Further, while the present disclosure describes the system (101) in the context of automotive applications, it may be appreciated by those skilled in the art that the system (101) may also be suitably adapted for other non-automotive applications that require a plurality of motors for their operations.

In some embodiments, the VFMMs (106) may be indicative of synchronous electric motors whose flux linkage (λₘ) may be dynamically, and operably, adjustable. The VFMMs (106) may be a type of synchronous motor in which the magnetization state of rotor magnets thereof may be adjusted (i.e., changed) during an operation of the VFMMs (106). Adjusting magnetization states of the rotor magnets (hereinafter referred to as “VFMM magnetization” or “magnetization state”) may correspondingly change the amount of torque or propulsion provided by the VFMMs (106) with respect to the electric power supplied thereto.

In some embodiments, the VFMMs (106) may have a set of phase windings. In some embodiments, the set of phase windings may correspond to the coils on the stator of the VFMMs (106). In some embodiments, the VFMMs (106) may be electrically connected to a power source, such as the battery (108). When the battery (108) supplies electric power to the VFMMs (106), the coils of the stator may produce a magnetic field, which may interact with the magnetic fields of the rotor magnets of a rotor. In such embodiments, the interaction of the magnetic fields may cause the rotor to rotate with respect to the stator, and in-turn cause the wheels (112) connected thereto through the drivetrains (104) to rotate and propel the vehicle (102) in a direction on the transverse plane of the vehicle (102). In some preferred embodiments, the VFMMs (106) may have multi-phase windings to operate with multi-phase electric power supplied from the battery (108) through the inverter (114). In some non-limiting examples, multi-phase windings may be indicative of three-phase windings. In such non-limiting examples, the VFMMs (106) may have either a star connection or a delta connection, but not limited thereto.

According to one or more embodiments, to facilitate the change in the magnetization state of the VFMMs (106), the rotor magnets may be made of a soft-ferromagnetic material including, but not limited to, aluminum nickel cobalt (AlNiCo) or some types of ceramics. Hereinafter, the rotor magnets made of a soft-ferromagnetic material will be referred to as “soft magnets.” The soft magnets may be magnets having coercive force less than a coercive force threshold. The soft magnets may be configured to produce magnetomotive forces (mmf) when magnetized. According to one or more embodiments, the soft magnets may be made of AlNiCo with grades 1-9 or magnets made of AlNiCo, cast, ceramics, some grades of samarium cobalt, or sintered construction of these materials. It may be apparent to those skilled in the art that specific amounts of these materials may be used to achieve a desired function of the VFMMs (106). The design, construction, number, and arrangements of the stator, the rotor, and the soft magnets may be suitably adapted based on requirements of the use cases. In some non-limiting examples, the VFMMs (106) may correspond to those provided in patent specifications WO2020210495A1, US20220407374A1, and/or WO2021081372A1.

The VFMMs (106), in accordance with one or more embodiments, may be a better substitute for conventional synchronous motors due to their ability to be variably magnetized and demagnetized based on requirements. In some embodiments, the soft magnets can be quickly and efficiently magnetized and/or demagnetized during, and after, the soft magnets are assembled inside the VFMMs (106). Accordingly, using VFMMs (106) potentially reduces manufacturing costs of electric motor-equipped system (101) due to easier handling of the demagnetized materials, during and after assembly by eliminating need for reconfiguration or replacement of soft-magnets if they are found to be of inappropriate magnetization states.

In some embodiments, the magnetization states of the soft magnets may be changed to any value from about 0% magnetization (i.e., the soft magnets are completely demagnetized) to about 100% magnetization (i.e., the soft magnets are magnetized to their maximum capacity). The change in the magnetization states may occur in a short time span, i.e. in less than about 3 milliseconds. In some embodiments, the magnetization states of the VFMMs (106) may be changed by passing a pulse of current therethrough such that the soft magnets are magnetized or de-magnetized up to the desired level. The magnetization state of the soft magnets may be adjusted by amplitude of the pulse of current. In some embodiments, the pulse of current may be provided to the soft magnets by the battery (108). In some embodiments, the inverter (114) may be connected to a corresponding inverter controller (such as controller (110) described subsequently) that may be configured to adjust the pulse to shift the magnetization state of the soft magnets. In some embodiments, the pulse of current from the battery (108) may be modified or channeled through the inverter (114).

By suitably adjusting the magnetization states of the VFMMs (106), one or more of the VFMMs from the set of VFMMs (106) may be operably engaged or disengaged from providing power to the drivetrains (104). In some embodiments, when the VFMMs (106) (or the rotor magnets thereof) are magnetized, the VFMMs (106) may provide power to the drivetrains (104), and when the VFMMs (106) are demagnetized completely, the VFMMs (106) may be prevented from providing power to the corresponding drivetrain (104). In such embodiments, the demagnetized VFMMs (106) may eliminate rollover losses otherwise experienced with other permanent magnet motors. Further, demagnetizing the VFMMs (106) may allow the rotors to spin freely, thereby preventing iron, eddy, and copper losses at speeds exceeding a predetermined threshold. The predetermined threshold may depend on power required by the users, such as torque and/or speed requirements, as elaborated subsequently in the present disclosure.

In some embodiments, each of the VFMMs (106) may have different operating configurations/specifications. In some embodiments, the configurations/specifications of the VFMMs (106) include, but not be limited to, number of turns on coils associated therewith, sizes and geometry of the rotor with respect to the stator, material composition of the rotors, and the like. Each VFMM from the set of VFMMs (106) may have a different specification that is optimized to operate at a corresponding power and/or speed requirements, or fit the requirements of a desired drive cycle. In some embodiments, a first subset of VFMMs may be defined to provide torque higher than a torque capacity value, but speed lower than a speed capacity value. Further, in such embodiments, a second subset of VFMMs may be defined to provide torque less than the torque capacity threshold, but speed higher than the speed capacity threshold. In some examples, the first VFMM (106-1) may have optimized specifications for operation in comparatively low-speed, high-torque situations, such as during acceleration or uphill climbs, and the second VFMM (106-2) may have optimized specifications for comparatively high-speed, low-torque situations, such as while driving on a freeway. Having VFMMs (106) with different specifications may allow the system (101) to be operable at optimal efficiency in a plurality of power requirements.

In some embodiments, the VFMMs (106) may receive power from the power source (203). The power source (203) may be any one or combination of including, but not limited to, batteries (such as battery 108), power outlets connected to a power grid, solar panels, hydrogen fuel cells, generators, and the like. In some embodiments, the battery (108) may be made of any one or combination of including, but not limited to, lithium-ion, lithium-ion polymer, nickel metal hydride, nickel cadmium, nickel hydrogen, nickel-zinc, silver zinc, and the like. In some embodiments, the power source (203) may be indicative of one or more of the battery (108) forming a battery stack. In some embodiments, the power source (203) may be connected to the VFMMs (106) in series or in parallel. In some embodiments, the power source (203) may be electrically connected directly to the VFMMs (106), or through the inverter (114).

In some embodiments, the one or more inverters (114) may be configured between the battery (108) and the set of VFMMs (106), and may be configured to allow the electric power to pass therebetween. The inverters (114) may convert the electric power indicative of Direct Current (DC) to Alternating Current (AC) from the battery (108), and supply the electric power to the VFMMs (106). In some embodiments, the inverters (114) may be configured to modulate the frequency of the AC based on the speed requirements. In some embodiments, the inverters (114) may be a multi-phase inverter. In an example, the multi-phase inverter may be a three-phase inverter. In other examples, the multi-phase inverter may be an inverter having more than one phase. In some embodiments, the inverters (114) may electrically connect the VFMMs (106) and the battery (108). In some embodiments, the inverters (114) may be used for re-magnetizing the soft magnets in the VFMMs (106) by controllably passing a pulse of electric current through the VFMMs (106).

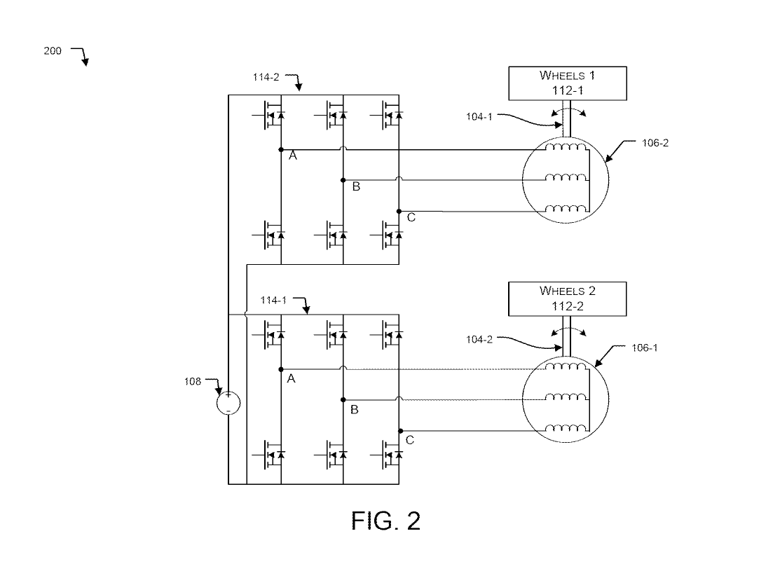

In some embodiments, each VFMM, or a subset of VFMMs, from the set of VFMMs (106) may be connected to a corresponding inverter (114). As shown in FIG. 2, the first VFMM (106-1) and the second VFMM (106-2) may be connected to a first inverter (114-1) and a second inverter (114-2), respectively. The controller (110) may be configured to operably engage a subset of inverters from the one or more inverters (114) to electric power to pass therethrough, based on the power requirements. In such embodiments, the controller (110) may be configured to operably engage the subset of inverters to increase the power ratings in proportion to electric power required for fulfilling the power requirements. In some examples, the first and the second inverters (114-1, 114-2) may be configured to supply electric power to the VFMMs (106).

In some embodiments, the controller (110) may be configured to selectively change a magnetization state of one or more VFMMs from the set of VFMMs (106) based on power requirements, thereby selectively engaging or disengaging the VFMMs (106) based on power requirements. In some embodiments, the controller (110) may include a processor (e.g., a Central Processing Unit (CPU)) coupled to a memory (e.g., a Random Access Memory (RAM)). The memory may have one or more processor-executable instructions for selectively changing the magnetization states of the VFMMs (106). In some embodiments, the controller (110) may be indicative of on-board electronics, such as an Electronic Control Unit, or a Vehicle Control Unit (VCU).

In some embodiments, to change the magnetization state, the controller (110) may be configured to receive the power requirements. The power requirements may be indicative of speed and torque required on the drivetrains (104). In some embodiments, the controller (110) may be configured to receive inputs indicative of power requirements from a user of the vehicle (102) through one or more interfaces (not shown). The interfaces may be any one or combination of including, but not limited to, a shift knob, a button, a grip shift, a foot pedal, a rotary knob, a voice command receiver, biomedical implants, and the like. In other embodiments, the controller (110) may receive indications of the power requirements through one or more sensors (not shown) that transmit one or more environmental parameters thereto. The environmental parameters may be any one or combination of including, but not limited to, rain detection parameters, surface friction parameters, temperature parameters, tire pressure parameters, surface gradient parameters, component health parameters, suspension compression parameters, and the like. In such embodiments, the controller (110) may be configured to infer the power requirements based on the one or more environmental parameters. In other embodiments, the controller (110) may be configured to determine the power requirements based on a combination of the inputs from the one or more interfaces, and the one or more environmental parameters from the sensors.

In some embodiments, the controller (110) may be configured to determine an optimal magnetization configuration for the set of VFMMs (106) based on the power requirements. In some embodiments, the optimal magnetization configuration may be indicative of a combination of magnetization states of each VFMM in the set of VFMMs (106) that is optimal for fulfilling the power requirements, but not limited to. In some embodiments, the controller (110) may be configured to determine the optimal magnetization configuration based on the power requirements falling between a predetermined set of threshold ranges. In such embodiments, a combination of magnetization states of each of the VFMMs (106) may be determined for each of the threshold ranges such that for every power requirement falling within any one of the threshold ranges, there exists at least one combination of magnetization state that optimally/efficiently fulfills the power requirements.

In some embodiments, the controller (110) may be configured to demagnetize a first subset of VFMMs from the set of VFMMs (106), such as the first VFMM (106-1), and magnetize a second subset of VFMMs from the set of VFMMs (106), such as the second VFMM (106-2), when the power requirements are below a predetermined threshold. In such embodiments, the controller (110) may be configured to turn off the inverter (114) associated with the first subset of VFMMs therefrom to prevent the stators thereof from producing magnetic fields. Further, in such embodiments, the controller (110) may be configured to connect the second subset of VFMMs with the associated axles (104), or retain connection of the second subset of VFMMs. In some examples, the power requirement may be below the predetermined threshold when the user is driving the vehicle (102) in cities where speed and power requirements may be lower. In such embodiments, the first subset of VFMMs, since they are demagnetized, the first subset of VFMMs may minimize or eliminate any rollover losses therefrom. In such embodiments, the stator may be de-energized. Meanwhile, the second subset of VFMMs may continue to interact with the magnetic field of the stator, and may propel the drivetrains (104) corresponding to the power requirements. When the power requirements exceed the predetermined threshold, the controller (110) may be configured to magnetize the first subset of VFMMs to fulfill the power requirements of the user. In some embodiments, where speed and power requirements may be higher, such as when the user moves from city roads to a freeway, or requires the vehicle (102) to perform an uphill climb, for example, the controller (110) may magnetize the first subset of VFMMs to allow both subsets of VFMMs to engage with and provide power to the wheels, thereby causing it to interact with the magnetic fields produced by the corresponding stators, and generate additional torque or speed to fulfill the power requirements.

In some embodiments, one or more of the VFMMs from the set of VFMMs (106) may be either fully or partially (de)magnetized based on the power requirements. In such embodiments, the one or more VFMMs may be magnetized in a combination that allows the system (101) to achieve a target efficiency (or power efficiency).

In some embodiments, the optimal magnetization configuration may be determined based on the specifications of each of the VFMMs (106). In some examples, the first VFMM (106-1) with a higher number of turns may be configured to generate more torque, but less speed, than the second VFMM (106-2) which has a comparatively lower number of turns. In such examples, when the power requirements indicate a need for torque, the controller (110) may be configured to demagnetize the second VFMM (106-2) and magnetize the first VFMM (106-1). In other examples when the power requirements indicate a need for increased speed (such as greater than a predefined speed threshold), the first VFMM (106-1) may be demagnetized and the second VFMM (106-2) may be magnetized to provide speed greater than the predefined threshold more efficiently. In yet other examples, the first and the second VFMMs (106-1, 106-2) may be partially magnetized in a proportion appropriate to provide torque and speed corresponding to the power requirements.

In such embodiments, the controller (110) may determine a combination of magnetization states each VFMM in the set of VFMMs (106) may have for a given power requirement in-real time. In other embodiments, the controller (110) may retrieve, from a database coupled thereto, a combination of magnetization states each VFMM in the set of VFMMs (106) may have for the given power requirement, that has been predetermined and stored in the database. In such embodiments, the combinations of magnetization states may be stored in the database, and may be retrieved by matching an entry corresponding to the power requirement.

In other embodiments, the optimal magnetization configuration may be indicative of a combination of magnetization states of the VFMMs (106) that provides power corresponding to the power requirements within the target efficiency. In such embodiments, the controller (110) may be configured to adjust the magnetization states of the VFMMs (106) based on the power requirements, without disconnecting the VFMMs (106) from the corresponding inverters (114). The controller (110) may select the optimal magnetization configuration for the VFMMs (106) to maximize the efficiency of power delivery. In some examples, the controller (110) may be configured to increase the magnetization states of the first subset of VFMMs configured to drive the front wheels (112-1, 112-2) and decrease the magnetization states of the second subset of VFMMs configured to drive the rear wheels (112-3, 112-4) during acceleration, and vice-versa during uphill climbs. In such examples, the VFMMs (106) may cumulatively provide torque and speed corresponding to the power requirements, while optimizing the power consumption thereof.

In some embodiments, the controller (110) may be configured to transmit a demagnetization pulse or a magnetization pulse to the one or more VFMMs in the set of VFMMs (106) to match the optimal magnetization configuration corresponding to the power requirements. In some embodiments, the demagnetization pulse and the magnetization pulse may be indicative of negative d-axis current pulses and positive d-axis current pulses, respectively, of a predetermined duration. The predetermined duration may correspond to the duration of pulses required to shift the VFMMs (106) from a current magnetization state to a desired magnetization state. The desired magnetization state may be determined based on the optimal magnetization configuration. In some embodiments, the demagnetization pulse and the magnetization pulse are transmitted through the inverter (114) corresponding to the VFMMs (106) for which the magnetization states thereof have to be changed.

In some embodiments, the controller (110) may be configured with fault-tolerance functionalities. During faults (such as short circuit currents), the VFMMs (106) may be demagnetized by the short-circuit currents. In such embodiments, the system (101) may ensure the vehicle (102) remains operational, while also allowing the allowing the VFMMs (106) to be recoverable.

FIG. 2 shows a circuit diagram (200) of the system (101), according to one or more embodiments. FIG. 2 illustrates a configuration where the inverters (114-1, 114-2) are connected to the corresponding VFMMs (106). In such embodiments, the system (101) may be configured to transmit power through the drivetrains (104) to rotate the wheels (112), and thereby propel the vehicle (102). The power with which each of the VFMMs (106) drives its corresponding drivetrain may depend on the magnetization states thereof. In some embodiments, the controller (110) may selectively adjust the magnetization states of each of the connected VFMMs (106) based on the optimal magnetization configuration.

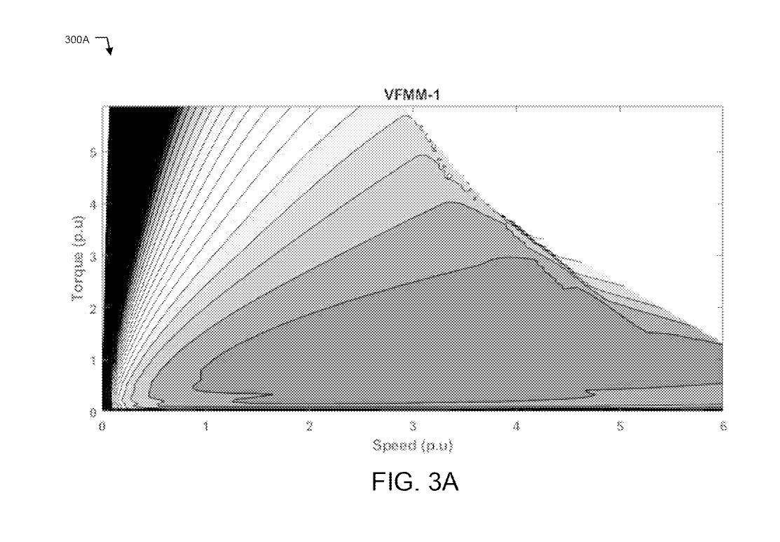

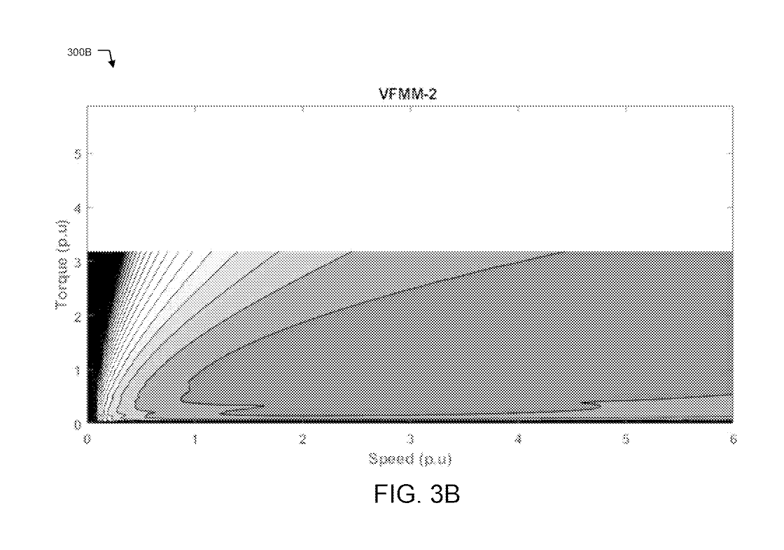

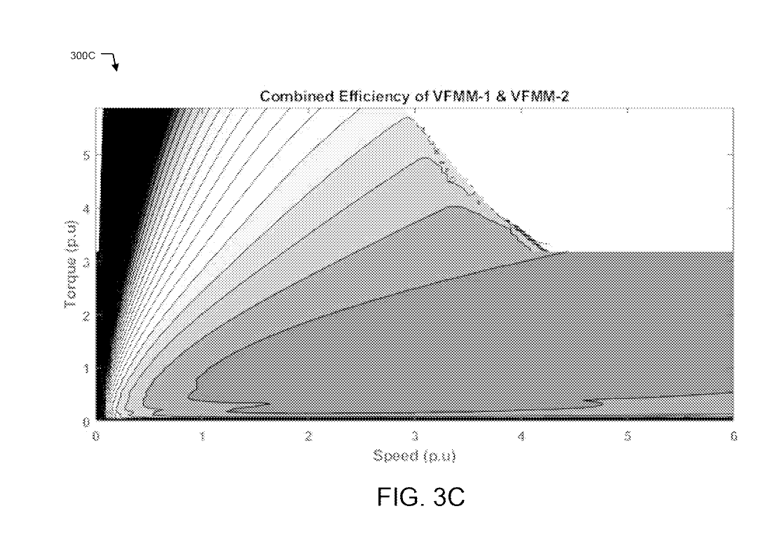

FIGS. 3A-3C show efficiency maps (300A, 300B, 300C) of the set of VFMMs (106), according to one or more embodiments. FIG. 3A shows the efficiency map (300A) of the first subset of VFMMs, FIG. 3B shows the efficiency map (300B) of the second subset of VFMMs, and FIG. 3C shows the combined efficiency map (300C) of the first and the second subsets of the VFMMs. The efficiency maps (300A, 300B, 300C) show the power efficiency of the set of VFMMs (106) with respect to speed and torque output from the VFMMs (106). Darker shades of gray indicate higher efficiency for power requirements with respect to speed and torque provided in X-axis and Y-axis, respectively. Drive cycle average efficiency, indicative of energy requirement, of the set of VFMMs (106), may be determined by calculating the Watt/hour consumed and the range at each drive cycle using coefficient of rolling resistance, drag coefficient, velocity and acceleration of the vehicle (102), torque and speed provided by the VFMMs (106), motor efficiencies determined using a loss models, and other vehicle parameters. As shown, the first and the second subsets of VFMMs may have different configurations/specifications suitably adapted for providing efficient power output based on power requirements. For example, the first subset of VFMMs may be adapted to provide increased efficiency for high-torque applications in comparison to the second subset of VFMMs, while the second subset of VFMMs may be adapted to provide increased efficiency for high-speed applications in comparison to the first subset of VFMMs. The power (torque and/or speed) efficiency of the VFMMs (106) may be suitably adapted by modifying the amount of coil windings, for example, used in the stator thereof. In some examples, the VFMMs (106) that are optimized to provide efficient speed output may have lower number of turns in comparison to the VFMMs (106) that are optimized to provide efficient torque output, which may have higher number of turns in its coils. The geometry, dimensions, and/or the number turns of the stator or the rotor in each of the VFMMs (106) may also be suitably adapted to provide different speed outputs and power outputs.

When the first and the second subsets of VFMMs are used in combination of the other, they may be able to provide torque and speed outputs with increased efficiency over a broader range of power requirements. In some examples, since the first subset of VFMMs provide increased efficiency while providing higher amounts of torque (as shown in efficiency map (300A)), in comparison to the second set of VFMMs, the first subset of VFMMs may be engaged when the user requires an increased amount of torque. Similarly, since the second subset of VFMMs provides increased efficiency while providing higher amounts of speed (as shown in efficiency map (300B)), in comparison to the first set of VFMMs, the second subset of VFMMs may be engaged when the user requires an increased amount of speed.

In some embodiments, by using VFMMs (106) with operably (de)magnetizable rotor magnets, the system (101) may eliminate the need for a clutch or axle disconnect means to disengage motors from the corresponding drivetrain (104). In such embodiments, the system (101) may benefit from reduction of cost, space, and weight associated with installing such clutches or axle disconnect means. Eliminating such components also reduces complexities associated with operably engaging and disengaging motors based on the power requirements, thereby increasing reliability of the system (101) and minimizing risk of failure. Use of a plurality of VFMMs (106) having different configurations may also provide for a wider range of operating power requirements. Since each of the VFMMs (106) can be optimized for different operating ranges, the controller (110) may selectively modify magnetization states of (or disconnect) the VFMMs (106) corresponding to the power requirements received from the users. Further, the system (101) may simplify the supply chain, manufacturing, and maximize inventory utilization. Additionally, the energy efficiencies of the set of VFMMs (106) at each drive cycle may allow for a reduction in battery capacities and sizes, which further reduces the weight of the vehicle (102).

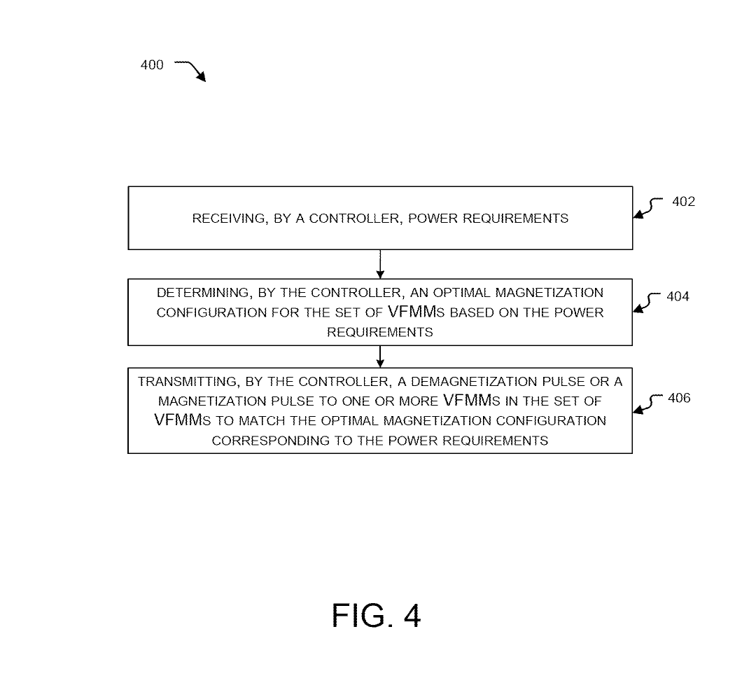

FIG. 4 illustrates a flowchart of a method (400) for controlling a set of VFMMs based on power requirements, according to one or more embodiments of the present disclosure.

At block 402, the method (400) includes receiving, by a controller, power requirements from one or more interfaces.

At block 404, the method (400) includes determining, by the controller, an optimal magnetization configuration for the set of VFMMs based on the power requirements.

At block 404, the method (400) includes transmitting, by the controller, a demagnetization pulse or a magnetization pulse to one or more VFMMs in the set of VFMMs to match the optimal magnetization configuration corresponding to the power requirements.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A system for multi-Variable Flux Memory Motor (VFMM) configuration, comprising:
a set of VFMMs connected to one or more drivetrains, the set of VFMMs being configured to convert kinetic energy of the one or more drivetrains into electric power or vice-versa; and
a controller configured to selectively change a magnetization state of one or more VFMMs from the set of VFMMs based on power requirements.
